(19) United States
(12) Patent Application Publication
(10) Pub. No.: US 2020/0079366 A1
(43) Pub. Date: Mar. 12, 2020

(54) AUTOMATIC DRIVING CONTROL SYSTEM FOR VEHICLE

(71) Applicant: DENSO CORPORATION, Kariya-city (JP)

(72) Inventors: Mitsuharu HIGASHITANI, Kariya-city (JP); Noriaki IKEMOTO, Kariya-city (JP); Tomomi HASE, Kariya-city (JP)

(73) Assignee: DENSO CORPORATION, Kariya-city (JP)

(21) Appl. No.: 16/681,011

(22) Filed: Nov. 12, 2019

Related U.S. Application Data
(63) Continuation of application No. PCT/JP2018/006184, filed on Feb. 21, 2018.

(30) Foreign Application Priority Data
May 12, 2017 (JP) 2017-095448

(51) Int. Cl. B60W 30/09; B60W 30/095; B60W 30/18; B60W 40/08; B60W 10/20; G06K 9/00; G08G 1/16

(52) U.S. Cl. CPC B60W 30/09; B60W 30/0956; B60W 30/18154; B60W 40/08; B60W 2540/18; G06K 9/00825; G08G 1/166; B60W 2550/30; B60W 10/20

(57) ABSTRACT

An automatic driving control system includes power sources, a relay device changing connection states of the power sources, a relay control device controlling the relay device, a status recognizing unit recognizing a status of the own vehicle on a planned traveling route, and an automatic driving control unit controlling automatic driving. The status recognizing unit recognizes that a collision probability of a collision with an object during the automatic driving is a predetermined threshold or more, and also recognizes a damage-expected power source included in the power sources and expected to be damaged in a collision with the object. When the collision probability is the predetermined threshold or more, the automatic driving control unit instructs the relay control device to disconnect the damage-expected power source from particular auxiliary units and to connect, to the particular auxiliary units, a power source that is not the damage-expected power source.

### CROSS REFERENCE TO RELATED APPLICATION

The present application is based on and claims the benefit of priority from earlier Japanese Patent Application No. 2017-95448 filed May 12, 2017, the description of which is incorporated herein by reference.

### BACKGROUND

### Technical Field

The present disclosure relates to an automatic driving control system for a vehicle.

### Related Art

An automatic driving system simulates obstacles and moving trajectories of an own vehicle, then calculates the degree of damage for each of the combinations of various objects (another vehicle, a guard rail, and the like) and moving trajectories, and automatically controls the vehicle so as to minimize the degree of damage.

### SUMMARY

As an aspect of the disclosure, an automatic driving control system is provided which is configured to perform automatic driving to cause an own vehicle to travel along a planned traveling route. The automatic driving control system includes: a plurality of power sources installed in the own vehicle and each capable of supplying power to particular auxiliary units of the own vehicle; a relay device changing connection states of the plurality of power sources for the particular auxiliary units; a relay control device controlling the relay device; a status recognizing unit capable of recognizing a status of the own vehicle on the planned traveling route and a status of an object around the own vehicle; and an automatic driving control unit indicating the connection states of the plurality of power sources to the relay control device and controlling automatic driving.

The status recognizing unit recognizes that a collision probability at which the own vehicle collides with the object during the automatic driving is equal to or more than a predetermined threshold, and in a case where the collision probability is equal to or more than the predetermined threshold, also recognizes a damage-expected power source included in the plurality of power sources and expected to be damaged in a collision with the object.

In a case where the collision probability is equal to or more than the predetermined threshold, the automatic driving control unit instructs the relay control device to disconnect the damage-expected power source from the particular auxiliary units and to connect, to the particular auxiliary units, one of the plurality of power sources that is not the damage-expected power source.

In a case where the status recognizing unit recognizes that the collision probability is equal to or more than the predetermined threshold, the status recognizing unit calculates a cost related to a plurality of automatic driving actions employable by the automatic driving control unit, employs an automatic driving action minimizing the cost, and determines a portion of the own vehicle expected to be hit by the object in the employed automatic driving action.

### BRIEF DESCRIPTION OF THE DRAWINGS

In the accompanying drawings:

FIG. 1 is a descriptive diagram illustrating a configuration of an automatic driving control unit as a first embodiment;

FIG. 2 is a descriptive diagram illustrating an example of a connection relationship between particular auxiliary units and power sources;

FIG. 3 is a flowchart illustrating a procedure for power source connection change processing according to a first embodiment;

FIG. 4 is a descriptive diagram illustrating a relationship between a vehicle speed and an inter-vehicular distance and a collision probability;

FIG. 5 is a flowchart illustrating a procedure for power source connection change processing according to a second embodiment;

FIG. 6 is a flowchart illustrating a determination procedure for a steering angle change status according to the second embodiment;

FIG. 7 is a conceptual drawing illustrating effects of steering angle change at an intersection;

FIG. 8 is a conceptual drawing illustrating the state of steering angle change in a vehicle;

FIG. 9 is a flowchart illustrating a determination procedure for the steering angle change status according to a third embodiment;

FIG. 10 is a flowchart illustrating a determination procedure for rear collision conditions according to the third embodiment;

FIG. 11 is a flowchart illustrating a determination procedure for the steering angle change status according to a fourth embodiment;

FIG. 12 is a flowchart illustrating a determination procedure for front collision conditions according to the fourth embodiment;

FIG. 13 is a descriptive diagram illustrating an example of a rush-out area in a rear collision;

FIG. 14 is a descriptive diagram illustrating a front collision caused by a rear collision;

FIG. 15 is a descriptive diagram of a collision probability of a front collision;

FIG. 16 is a flowchart illustrating a determination procedure for rear collision conditions according to a fifth embodiment;

FIG. 17 is a descriptive diagram illustrating the state of a merging collision according to a sixth embodiment;

FIG. 18 is a flowchart illustrating a determination procedure for the steering angle change status according to the sixth embodiment;

FIG. 19 is a descriptive diagram illustrating the state of a collision according to a seventh embodiment;

FIG. 20 is a flowchart illustrating a determination procedure for the steering angle change status according to the seventh embodiment;

FIG. 21 is a flowchart illustrating a procedure for power source connection change processing according to an eighth embodiment;

FIG. 22 is a descriptive diagram illustrating an example of a collision with a following vehicle traveling in a next lane;

FIG. 23 is a descriptive diagram illustrating another example of a collision with the following vehicle traveling in the next lane; and

FIG. 24 is a descriptive diagram illustrating yet another example of a collision with the following vehicle traveling in the next lane.

### DETAILED DESCRIPTION OF THE PREFERRED EMBODIMENTS

JP 2016-088134-A discloses an automatic driving system for a vehicle. The automatic driving system simulates obstacles and moving trajectories of an own vehicle, then calculates the degree of damage for each of the combinations of various objects (another vehicle, a guard rail, and the like) and moving trajectories, and automatically controls the vehicle so as to minimize the degree of damage. JP-2016-088134-A discloses that, for example, to be controlled so as to reduce the degree of damage, the own vehicle is brought into the guard rail and thus is stopped to protect pedestrians.

However, in fact, for known automatic driving systems, sufficient measures have not been taken to mitigate the effect of a collision with an other object in a power source system. The present inventors have found a problem in that, for example, in a case where a short circuit of the power source system or a power loss occurs in the own vehicle due to a collision with another vehicle, various failures or defects occur such as the loss of power supply to equipment for preventing secondary damage, possibly precluding the own vehicle from being safely operated.

### A. First Embodiment

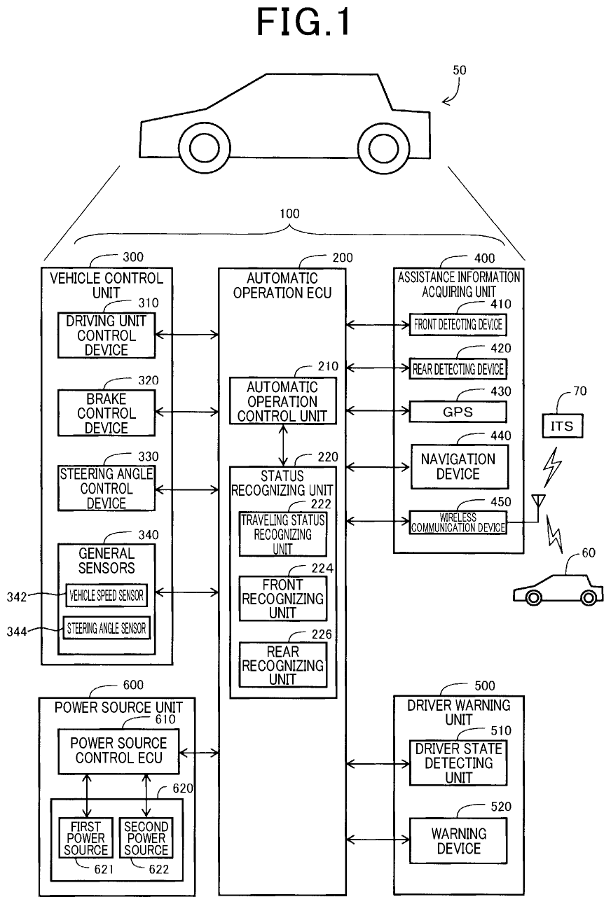

As illustrated in FIG. 1, a vehicle 50 of a first embodiment includes an automatic driving control system 100. The automatic driving control system 100 includes an automatic driving electronic control unit (ECU) 200, a vehicle control unit 300, an assistance information acquiring unit 400, a driver warning unit 500, and a power source unit 600. Note that the vehicle 50 is hereinafter also referred to as the “own vehicle 50”.

The automatic driving ECU 200 is a circuit including a CPU and a memory. The automatic driving ECU 200 functions as an automatic driving control unit 210 executing a computer program stored in a nonvolatile storage medium to control automatic driving of the vehicle 50, and a status recognizing unit 220 recognizing status related to the vehicle 50. Functions of the status recognizing unit 220 will be described below.

The vehicle control unit 300 is a part performing various types of control for driving of the vehicle 50 and is utilized both for automatic driving and for manual driving. The vehicle control unit 300 includes a driving unit control device 310, a brake control device 320, a steering angle control device 330, and general sensors 340. The driving unit control device 310 functions to control a driving unit (not illustrated) driving wheels of the vehicle 50. As the driving unit for the wheels, one or more of an internal combustion engine and an electric motor can be used as a prime motor. The brake control device 320 performs brake control on the vehicle 50. The brake control device 320 is configured, for example, as an electronic control brake (ECB) system. The steering angle control device 330 controls a steering angle of the wheels of the vehicle 50. Note that, in the first embodiment, the “steering angle” means the average steering angle of two front wheels of the vehicle 50. The steering angle control device 330 is configured, for example, as an electric power steering (EPS) system. The general sensors 340 include a vehicle speed sensor 342 and a steering angle sensor 344 and are needed for driving of the vehicle 50. The general sensors 340 include sensors utilized both for automatic driving and for manual driving.

The assistance information acquiring unit 400 acquires various types of assistance information for automatic driving. The assistance information acquiring unit 400 includes a front detection device 410, a rear detection device 420, a GPS device 430, a navigation device 440, and a wireless communication device 450. The navigation device 440 functions to determine a planned traveling route for automatic driving based on a destination and an own vehicle position detected by the GPS device 430. To determine and modify the planned traveling route, in addition to the GPS device 430, another sensor such as a gyroscope may be utilized. The front detection device 410 acquires information related to the status of an object or a road facility (lane, intersection, traffic signal, or the like) present in front of the own vehicle 50. The rear detection device 420 acquires information related to the status of an object or a road facility present in the rear of the own vehicle 50. Each of the front detection device 410 and the rear detection device 420 can be implemented using one or more detectors selected from various detectors, for example, a camera, a laser radar, and a millimeter-wave radar. The wireless communication device 450 can exchange status information related to the status of the own vehicle 50 and surroundings, with an intelligent transport system 70 through wireless communication, and can exchange status information through inter-vehicle communication with another vehicle 60 and road-to-vehicle communication with a roadside radio device installed in a road facility. The assistance information acquiring unit 400 may utilize the status information obtained via wireless communication to acquire part of information related to a traveling status of the own vehicle, information related to a front status of the own vehicle 50, and information related to a rear status of the own vehicle 50. Various types of assistance information acquired by the assistance information acquiring unit 400 are transmitted to the automatic driving ECU 200.

“Automatic driving” as used herein means driving that automatically performs all of driving unit control, brake control, and steering angle control without any driver's operation. Thus, in the automatic driving, an operating state of the driving unit, an operating state of a brake mechanism, and the steering angle of the wheels are automatically determined. “Manual driving” means driving in which the driver performs operation for the driving unit control (stepping-on of an accelerator pedal), operation for the brake control (stepping-on of a brake pedal), and operation for the steering angle control (rotation of a steering wheel).

The automatic driving control unit 210 controls the automatic driving based on the planned traveling route provided by the navigation device 440 and various statuses recognized by the status recognizing unit 220. Specifically, the automatic driving control unit 210 transmits, to the driving unit control device 310, a driving indication value indicating the operating state of the driving unit (engine or motor), transmits, to the brake control device 320, a brake indication value indicating the operating state of the brake mechanism, and transmits, to the steering angle control device 330, a steering angle indication value indicating the steering angle of the wheels. The control devices 310, 320, and 330 controls respective control target mechanisms in accordance with the provided indication values. Note that the various functions of the automatic driving control unit 210 can be implemented by artificial intelligence utilizing a learning algorithm, for example, deep learning.

The driver warning unit 500 includes a driver state detecting unit 510 and a warning device 520. The driver state detecting unit 510 includes a detector (not illustrated) such as a camera and functions to detect, for example, the state of the face or head of the driver of the own vehicle 50 to detect what state the driver is in. The warning device 520 is a device providing a warning to the driver in accordance with the status of the vehicle 50 or a detection result from the driver state detecting unit 510. The warning device 520 can be configured using one or more devices, for example, a voice generating device (speaker), an image display device, or a vibrator generating device vibrating an object in a vehicle cabin (for example, a steering wheel). Note that the driver warning unit 500 may be omitted.

The power source unit 600 is a part supplying power to units in the vehicle 50, and includes a power source control ECU 610 as a power source control device and a power source circuit 620. The power source circuit 620 includes a plurality of power sources 621 and 622. As the plurality of power sources 621 and 622, for example, secondary batteries or fuel cells can be utilized.

The status recognizing unit 220 implemented by the automatic driving ECU 200 includes a traveling status recognizing unit 222, a front recognizing unit 224, and a rear recognizing unit 226. The traveling status recognizing unit 222 functions to utilize various types of information and detected values provided by the assistance information acquiring unit 400 and the general sensors 340 to recognize the traveling status of the own vehicle 50. The front recognizing unit 224 utilizes information provided by the front detection device 410 to recognize the status of an object or a road facility (lane, intersection, traffic signal, or the like) present in front of the own vehicle 50. The rear recognizing unit 226 recognizes status related to an object or a road facility present in the rear of the own vehicle 50. For example, the front recognizing unit 224 and the rear recognizing unit 226 can recognize an approaching status in which an other object approaches the own vehicle 50. Note that some or all of the functions of the status recognizing unit 220 may be implemented by one or more ECUs separate from the automatic driving ECU 200.

The automatic driving control system 100 includes a large number of items of electronic equipment including the automatic driving ECU 200. The plurality of items of electronic equipment are connected together via an in-vehicle network such as a controller area network (CAN). Note that the configuration of the automatic driving control system 100 illustrated in FIG. 1 can be used for other embodiments described below.

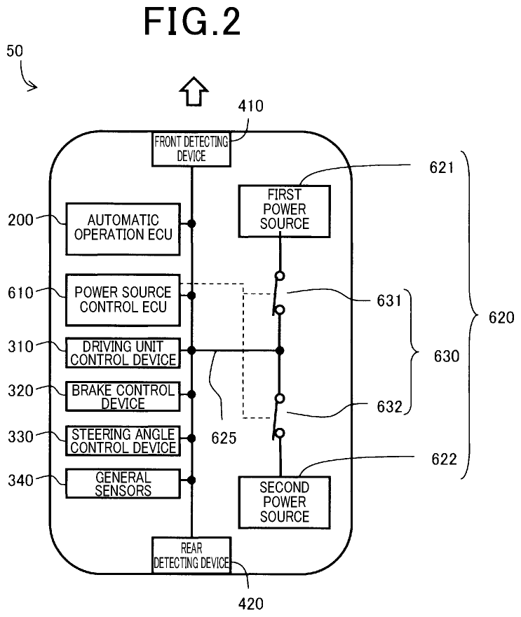

As illustrated in FIG. 2, the power source circuit 620 includes a plurality of power sources 621 and 622 and a relay device 630 including a plurality of relays 631 and 632, and power source wiring 625. In this example, the first power source 621 is connected to the power source wiring 625 via the first relay 631, and the second power source 622 is connected to the power source wiring 625 via the second relay 632. The power source wiring supplies power to a plurality of items of particular auxiliary equipment. Here, the particular auxiliary equipment illustrated in the figure include the front detection device 410, the rear detection device 420, the automatic driving ECU 200, the power source control ECU 610, the driving unit control device 310, the brake control device 320, the steering angle control device 330, and the general sensors 340. For example, the particular auxiliary equipment is particularly important equipment included in equipment needed to control the automatic driving. Note that the “auxiliary equipment” means equipment needed to cause the vehicle 50 to travel using the driving unit for the wheels (internal combustion engine or motor). The auxiliary equipment other than the particular auxiliary equipment may be connected to the power source system in FIG. 2 or to another power source system. In a normal connection state of the power source circuit 620, the plurality of power sources 621 and 622 are connected in parallel with a plurality of items of the particular auxiliary equipment as illustrated in FIG. 2. The power source control ECU 610 functions as a relay control device switching a connection state of the relay device 630. Note, in the example in FIG. 2, the relay device 630 has a simple configuration including the two relays 631 and 632 but that a relay device 630 with a more complicated configuration can be optionally employed. In general, the relay device 630 can be configured as a circuit including a plurality of relays capable of changing the connection state of the power source circuit 620.

The first power source 621 is installed near a front end portion of the vehicle 50, and the second power source 622 is installed neat a rear end portion of the vehicle 50. As is the case with this example, the plurality of power sources 621 and 622 are preferably disposed at different portions of the own vehicle 50. For example, the plurality of power sources 621 and 622 are preferably distributedly disposed at two or more different portions selected from the front end portion, rear end portion, right end portion, left end portion, and central portion of the vehicle 50. In the example in FIG. 2, two power sources are provided. However, three or more power sources may be provided. Additionally, in the power source circuit 620 in FIG. 2, an overcurrent protection circuit such as a fuse or an overvoltage protection circuit may be provided. Furthermore, for adjustment of a power source voltage, a DC-DC converter may be provided. For example, both the plurality of power sources 621 and 622 may be lead batteries. Alternatively, both the plurality of power sources 621 and 622 may be lithium-ion secondary batteries. Alternatively, both the plurality of power sources 621 and 622 may be nickel hydrogen batteries. Besides, as the plurality of power sources 621 and 622, a combination of various types of power sources can be utilized.

In a region where a traffic law specifying that vehicles drive on the left is applied, a partial collision from the left rear side of the vehicle is more likely than a partial collision from the right rear side of the vehicle. This is because the vehicle is located closer to the right end of a lane while waiting to make a right turn. Thus, in a case where the plurality of power sources 621 and 622 are installed in the rear of the vehicle, the power sources 621 and 622 are preferably installed in the right rear side of the vehicle. On the other hand, in a region where a traffic law specifying that vehicles drive on the right is applied, in contrast, the plurality of power sources 621 and 622 are preferably installed in the left rear side of the vehicle. Additionally, in a case where the plurality of power sources 621 and 622 are a combination of a lead battery and a lithium ion battery, a preferable layout is such that, in the vehicle, the lithium ion battery is located further inward than the lead battery. This allows the lithium ion battery, which generally provides high power and has a higher capability of supplying power to the particular auxiliary unit, to be located at a position where the lithium ion battery is less likely to be damaged in a collision than the lead battery. Additionally, another preferable layout is such that, in the vehicle, the lithium ion battery is disposed further forward than the lead battery. This allows the lithium ion battery to be located at a position where the lithium ion battery is less likely to be damaged in a collision from behind than the lead battery. In this case, for example, the lithium ion battery can be disposed in a space under a passenger's seat in the cabin or under an engine hood.

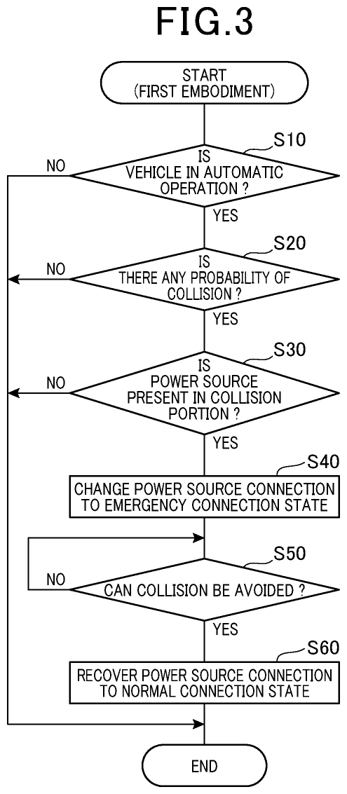

As described below, in a case where, in the first embodiment, the status recognizing unit 220 recognizes that a collision probability at which the own vehicle 50 collides with an other object is equal to or more than a predetermined threshold during automatic driving, the automatic driving control unit 210 causes the power source control ECU 610 to change the relay device 630 from a normal connection state to an emergency connection state. The flow of this power source connection switch processing is illustrated in FIG. 3.

The flow in FIG. 3 is periodically repeatedly executed by the automatic driving control unit 210 and the status recognizing unit 220 during driving of the vehicle 50. First, in step S10, whether the vehicle is in automatic driving is determined. In a case where the vehicle is not in automatic driving, processing in FIG. 3 is ended. In a case where the vehicle is in automatic driving, the processing proceeds to step S20 and subsequent steps. In step S20, the status recognizing unit 220 determines whether the own vehicle 50 may collide with an other object. This determination is executed by the status recognizing unit 220 based on various type of information acquired by the assistance information acquiring unit 400. As the other object, various objects can be assumed such as another vehicle traveling or stopped around the own vehicle 50, a pedestrian, and a road facility. Additionally, the collision probability can be calculated based on one or more parameters such as a relative distance between the own vehicle 50 and the other object, a relative speed, and traveling directions of the own vehicle 50 and the other object.

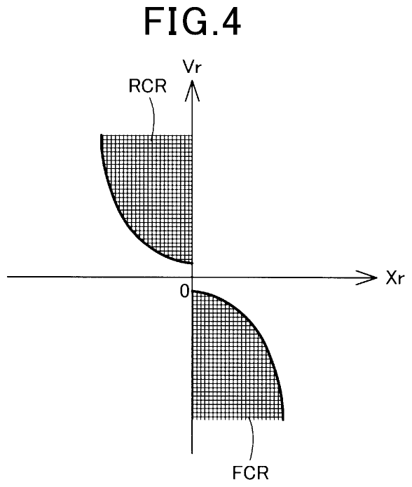

In a graph in FIG. 4, two areas RCR and FCR with a high collision probability are hatched. The horizontal axis of the graph indicates a relative distance Xr between the own vehicle 50 and the other object, and the vertical axis indicates a relative speed Vr. The relative distance Xr is plus when the other object is located in front of the own vehicle 50, and is minus when the other object is located behind the own vehicle 50. The relative speed Vr is plus in a case where the other object is faster than the own vehicle 50, and is minus in a case where the other object is slower than the own vehicle 50. The first area RCR is a rear collision area where the own vehicle 50 is likely to be rear-ended by the other object (for example, another vehicle). The second area FCR is a front collision area where the own vehicle 50 is likely to collide with the other object located in front of the own vehicle 50. As appreciated from this example, the collision probability tends to increase with decreasing the absolute value of the relative distance Xr and with increasing the absolute value of the relative speed Vr. The collision probability can be calculated based on a plurality of parameters including at least the relative distance Xr and the relative speed Vr.

The status recognizing unit 220 determines that there is no collision probability in a case where the collision probability at which the own vehicle 50 collides with the other object is less than a predetermined threshold (prescribed collision threshold). In this case, the processing in FIG. 3 is ended. On the other hand, the status recognizing unit 220 determines that there is a collision probability in a case where the collision probability is equal to or more than the predetermined threshold, and the processing proceeds to step S30.

In step S30, the status recognizing unit 220 recognizes a portion of the own vehicle 50 expected to be damaged in a collision with the other object, and determines which of the plurality of power sources 621 and 622 is installed in that portion. For example, in the example in FIG. 2, the status recognizing unit 220 recognizes that, in a case where the own vehicle 50 is rear-ended, a portion of the own vehicle 50 near the rear end portion may be damaged. The second power source 622 is installed in that portion, and thus the determination in step S30 is affirmed. The power source 622 that is installed at the portion expected to be damaged in a collision and that is expected to be damaged in a collision with the other object is hereinafter referred to as a “damage-expected power source”. Which portion is damaged in a collision can be estimated based on comprehensive consideration of a plurality of parameters such as a mechanical structure of the own vehicle 50, the relative speed of the own vehicle 50 relative to the other object, a collision direction, and the size and weight of the other object. Those of the plurality of parameters to which the other object is related are acquired by the assistance information acquiring unit 400. Additionally, information related to the mechanical structure of the own vehicle 50 can be acquired from a nonvolatile memory (not illustrated) in the automatic driving control system 100. In a case where negative determination is made in step S30, the processing in FIG. 3 is ended. That is, in this case, the power source circuit 620 is maintained in the normal connection state. On the other hand, in a case where affirmative determination is made in step S30, the processing proceeds to step S40.

In step S40, the automatic driving control unit 210 causes the power source control ECU 610 to instruct the relay device 630 to change from the normal connection state to the emergency connection state. The emergency connection state is a state where the damage-expected power source installed at the portion excepted to be damaged in a collision is disconnected from the particular auxiliary units and where the power source other than the damage-expected power source is connected to the particular auxiliary units. In the example in FIG. 2, the emergency connection state is a state where the first relay 631 is on, whereas the second relay 632 is off. Thus, even in a case where a collision has occurred to damage the own vehicle 50, power can be continuously supplied to the particular auxiliary units, enabling a reduction in the probability of secondary damage resulting from a power loss in the particular auxiliary units. This also enables reduction in the probability that damage to the damage-expected power source causes an overcurrent or an overvoltage, thus damaging another power source system. As a result, the own vehicle 50 can be safely operated.

The particular auxiliary units to which power is supplied by the power source in the emergency connection state may include at least one of the automatic driving control unit 210, the status recognizing unit 220, the brake control device 320, and the steering angle control device 330. In terms of safety stoppage of the own vehicle 50 after a collision, among the various auxiliary units, the brake control device 320 may be most important, and the automatic driving control unit 210, the status recognizing unit 220, and the steering angle control device 330 may be second most important. Thus, the particular auxiliary units to which power is supplied by the power source in the emergency connection state preferably include at least the brake control device 320 and more preferably include the automatic driving control unit 210, the status recognizing unit 220, and the steering angle control device 330, in addition to the brake control device 320.

Even in a case where the power source unit 600 includes three or more power sources, in the emergency connection state, the damage-expected power source installed at the portion excepted to be damaged in a collision can be disconnected from the particular auxiliary units, and one or more power sources other than the damage-expected power source can be connected to the particular auxiliary units. At this time, in a case where, in the emergency connection state, two or more power sources other than the damage-expected power source are connected to the particular auxiliary units, the probability of secondary damage resulting from damage to the damage-expected power source or a power loss in the particular auxiliary units can be further reduced, and the own vehicle 50 can be more safely driven.

After the change to the emergency connection state in step S40, whether a possible collision has been avoided is determined in step S50. This determination is determination of whether the probability of collision determined in step S20 has been eliminated. Step S50 is repeatedly executed until the possible collision is avoided. In a case where the possible collision is avoided, the processing proceeds to the next step S60. In step S60, the automatic driving control unit 210 causes the power source control ECU 610 to recover the power source circuit 620 to the normal connection state.

As described above, in the first embodiment, in a case where the collision probability at which the own vehicle 50 collides with the other object is equal to or more than the predetermined threshold, the automatic driving control unit 210 instructs the power source control ECU 610 to disconnect, from the particular auxiliary units, the damage-expected power source excepted to be hit by the other object and to connect one or more power sources other than the damage-expected power source to the particular auxiliary units. As a result, even in a case where a collision occurs, power can be continuously supplied to the particular auxiliary units, enabling reduction in the probability of secondary damage resulting from damage to the damage-expected power source or a power loss in the particular auxiliary units. Additionally, the own vehicle 50 can be safely operated.

### B. Second Embodiment

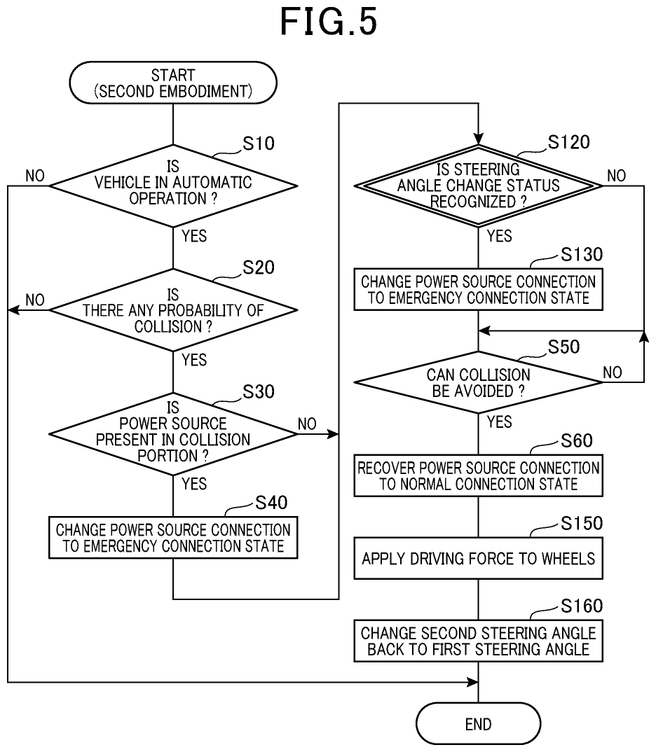

As illustrated in FIG. 5, in a procedure for power source connection change processing according to the second embodiment, steps S120 and S130 are additionally provided between step S40 and step S50 in FIG. 3, and steps S150 and S160 are additionally provided after step S60. Note that, in the processing procedure in FIG. 5, in a case where negative determination is made in step S30, the processing proceeds to step S120.

In steps S120 and S130, in a case where the status recognizing unit 220 recognizes a prescribed steering angle change status while the own vehicle 50 is temporarily stopped or traveling slowly near the center of an intersection, the automatic driving control unit 210 changes a first steering angle (first steering angle indicated by a steering angle indication value for automatic driving) along the planned traveling route to a second steering angle different from the first steering angle to mitigate the effect of rear-ending of the own vehicle 50 by another vehicle. Note that actual change in steering angle is effected by the automatic driving control unit 210 by causing the steering angle control device 330 to change the steering angle. The same reference signs as those in the first embodiment denote the same components, and for these components, the above description is referenced. This also applies to other embodiments described below.

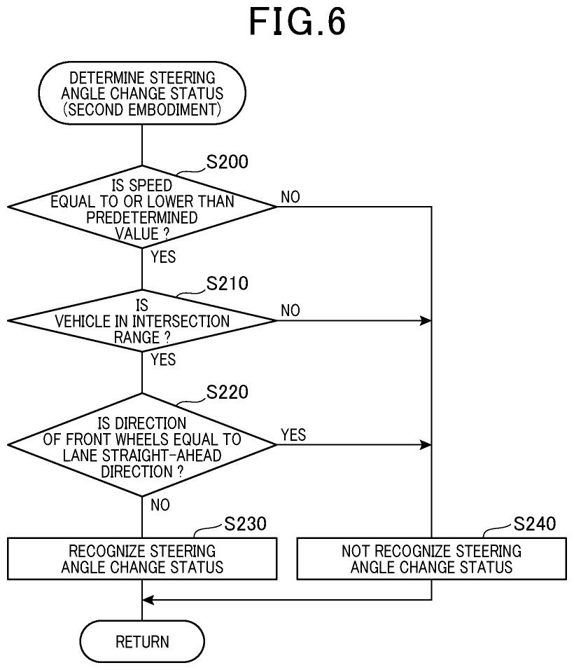

After the power source 620 changes from the normal connection state to the emergency connection state in step S40, whether the status recognizing unit 220 recognizes the prescribed steering angle change status is determined in step S120. In a case where the status recognizing unit 220 recognizes the steering angle change status, the steering angle for the vehicle 50 changes from the first steering angle along the planned traveling route to the second steering angle in step S130. In a case where the status recognizing unit 220 does not recognize the steering angle change status, the first steering angle remains unchanged and the processing proceeds to step S50. An example of a detailed procedure for step S120 in the second embodiment is illustrated in FIG. 6.

As illustrated in FIG. 6, in steps S200, S210, and S220 of the determination processing for the steering angle change status, it is determined whether the three conditions below are all established.

<Condition 1> The vehicle speed of the own vehicle 50 is equal to or less than a predetermined value.
<Condition 2> The own vehicle 50 is located within a predetermined range from the center of the intersection.
<Condition 3> The direction of the front wheels of the own vehicle 50 is not parallel to the lane straight-ahead direction at the intersection.

The “predetermined value” of the vehicle speed in condition 1 is a vehicle speed at which the own vehicle 50 can be estimated to be substantially stopped, and is set to, for example, 2 km/hour or less. Note that the “predetermined value” may be zero such that condition 1 is satisfied only when the own vehicle 50 is stopped. The “predetermined range from the center of the intersection” in condition 2 is appropriately preset in accordance with the size of the intersection, the width of the road, or the like. The “lane straight-ahead direction at the intersection” in condition 3 means the straight-ahead direction of the lane where the own vehicle 50 travels before entering the intersection.

In a case where conditions 1 to 3 described above are all satisfied, the processing proceeds to step S230, and the status recognizing unit 220 recognizes the steering angle change status. On the other hand, in a case where at least one of conditions 1 to 3 is not satisfied, the processing proceeds to step S240, and the steering angle change status is not recognized. Note that conditions 1 to 3 all relate to the traveling status of the own vehicle 50 and are also referred to as the “traveling status conditions”.

Of the above-described traveling status conditions, conditions 2 and 3 may be omitted, and traveling status conditions including at least condition 1 described above are preferably employed. For example, in a case where the own vehicle 50 is present at a position other than the position near an intersection, conditions 2 and 3 are appropriately changed according to the position. Such examples will be described in other embodiments. Additionally, conditions for recognition of the steering angle change status can additionally include a condition related to the rear status of the own vehicle 50 and a condition related to the front status of the own vehicle 50, besides the traveling status conditions for the own vehicle 50. This will also be described in other embodiments.

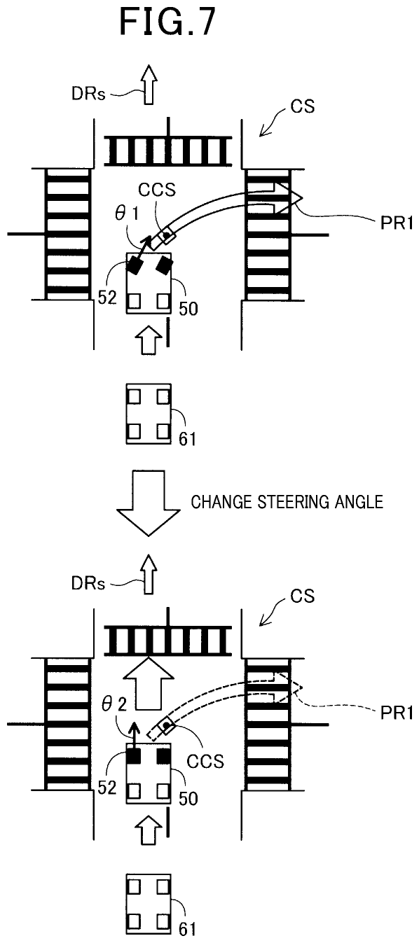

FIG. 7 illustrates a state where the steering angle change status is recognized in accordance with the processing flow in FIG. 6. The upper portion of FIG. 7 illustrates that the own vehicle 50 is stopped near a center CCS of an intersection CS in order to make a right turn at the intersection CS along a planned traveling route PR1. Another vehicle (hereinafter referred to as the “following vehicle 61”) is approaching the own vehicle 50 from behind. In the present embodiment, the following vehicle 61 is a vehicle traveling in the same lane where the own vehicle 50 travels. In a case where the own vehicle 50 is temporarily stopped or traveling slowly in order to make a turn at the intersection CS as described above and is rear-ended by the following vehicle 61, the own vehicle 50 rushes out (is shunted) into the opposite lane and is likely to collide with an other object (vehicle, human being, or the like). Thus, the steering angle is preferably changed to prevent the own vehicle 50 from rushing out along the planned traveling route PR1 even in a case where the own vehicle 50 is rear-ended.

A first steering angle θ1 of front wheels 52 of the own vehicle 50 is an angle indicated by the steering angle indication value for automatic driving in order to travel along the planned traveling route PR1. In a case where the own vehicle 50 makes a turn at the intersection CS, the direction of the front wheels 52 at the first steering angle θ1 is different from a lane straight-ahead direction DRs at the intersection CS. Additionally, the direction of the front wheels 52 at the first steering angle θ1 is often different from a neutral direction in which the steering angle is zero (direction parallel to a front-rear direction of the own vehicle 50). Note that manners for making a turn at the intersection CS include a right turn, a left turn, and a U turn. In the example in FIG. 7, the first steering angle θ1 is an angle at which the front wheels 52 are directed rightward for a right turn. The planned traveling route PR1 based on the first steering angle θ1 is a right-turn route as illustrated by a solid arrow. In this state, in a case where conditions 1 to 3 in steps S200 to S220 in FIG. 6 are all satisfied, the first steering angle θ1 is changed to a second steering angle θ2 as illustrated in the lower portion of FIG. 7. In this example, the second steering angle θ2 is an angle at which the front wheels 52 are directed parallel to the lane straight-ahead direction DRs. In this manner, when the steering angle change status (steps S200 to S220) is recognized, the first steering angle θ1 along the planned traveling route is changed to the second steering angle θ2, which is different from the first steering angle θ1. Then, even in a case where the own vehicle 50 is temporarily stopped or traveling slowly and is rear-ended by the following vehicle 61, the own vehicle 50 is prevented from being pushed out into the opposite lane because the steering angle of the front wheels 52 is equal to the second steering angle θ2, in other words, the own vehicle 50 is pushed out along the second steering angle θ2. As a result, the own vehicle 50 is prevented from being pushed out into the opposite lane. In other words, a possible head-on collision with an oncoming vehicle can be avoided. On the other hand, when the following vehicle 61 collides hard, the own vehicle 50 is assumed to be pushed out into the opposite lane with front wheels 52 unrotated. Even in that case, according to the configuration of the present embodiment, since the front wheels 52 are set at the second steering angle θ2, the front wheels 52 rub against the ground to function as a stopper, enabling a reduction in a distance over which the own vehicle 50 rushes out. As a result, the effect of pushing the own vehicle 50 out into the opposite lane can be reduced.

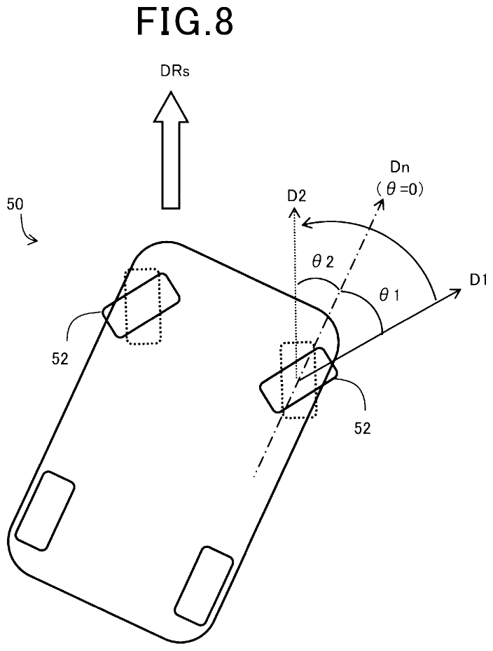

As illustrated in FIG. 8, the second steering angle θ2 employed when the steering angle change status is recognized is preferably an angle changing and making the direction of the front wheels 52 closer to the lane straight-ahead direction DRs than the first steering angle θ1. Note that, when the own vehicle 50 is temporarily stopped or traveling slowly in order to make a turn at the intersection CS, the front-rear direction of the own vehicle 50 is often inclined with respect to the lane straight-ahead direction DRs as in the example in FIG. 8. With such a case taken into account, the second steering angle θ2 resulting from change is preferably an angle setting the direction of the front wheels 52 parallel to the front-rear direction of the own vehicle 50 (this direction is hereinafter referred to as the “neutral direction Dn”) or an angle setting the direction of the front wheels 52 equal to a direction D2 opposite, across the neutral direction Dn, to a direction D1 indicated by the first steering angle θ1. In the example in FIG. 8, the first steering angle θ1 is a steering angle bending the traveling direction rightward, and the second steering angle θ2 is a steering angle setting the direction of the front wheels 52 equal to the lane straight-ahead direction DRs. Note that the direction of the front wheels 52 at the second steering angle θ2 is preferably close to the lane straight-ahead direction DRs, and is such that, for example, the angle between the direction of the front wheels 52 and the lane straight-ahead direction DRs is in the range of approximately ±10 degrees. Thus, even in a case where the own vehicle 50 is rear-ended by another vehicle, the probability that the own vehicle 50 is pushed out along the first steering angle θ1 into the opposite lane can be further reduced. Note that the value of the second steering angle θ2 can be appropriately determined in accordance with one or more parameters such as the size of the intersection, the width of the road, the vehicle speed of the own vehicle 50, and the vehicle speed of the following vehicle 61.

Referring back to FIG. 5, in a case where the steering angle change status is recognized in step S120, the first steering angle θ1 is changed to the second steering angle θ2 in step S130. In the next step S50, whether a possible collision has been avoided is determined. In this case, affirmative determination is made in a case where there is no probability that the own vehicle 50 is rear-ended by the following vehicle 61 at the intersection CS and where traveling of the own vehicle 50 can be started in accordance with a change in surrounding traffic status. Note that the own vehicle 50 “starting traveling” means that the vehicle speed exceeds the value in step S200 in FIG. 5. For example, in a case where the own vehicle 50 is stopped in step S200, “starting traveling” means that the vehicle speed has a value that is not zero. Additionally, in a case where the own vehicle 50 is traveling slowly at a speed equal to or lower than a predetermined speed, “starting traveling” means that the vehicle speed has a value exceeding the slow traveling speed. Step S50 is repeated at predetermined time intervals until affirmative determination is made.

In a case where affirmative determination is made in step S50, in step S60, the automatic driving control unit 210 causes the power source control ECU 610 to recover the power source circuit 620 to the normal connection state. This processing is the same as that in step S60 (FIG. 3) in the first embodiment. In the next step S150, the automatic driving control unit 210 transmits an instruction to the driving unit control device 310 to apply a driving force to the wheels of the own vehicle 50. Subsequently, in step S160, the automatic driving control unit 210 transmits an instruction to the steering angle control device 330 to set the second steering angle θ2 back to the first steering angle θ1. In this manner, in the second embodiment, the second steering angle θ2 is held until the driving force is applied to the wheels of the own vehicle 50 in step S150. Then, the steering angle is not changed until the wheels start to move, allowing inhibition of damage to the wheels and suppression of power consumption of the steering angle control device 330. However, the execution order of step S150 and step S160 may be reversed. This allows the own vehicle 50 to travel along a route close to the original planned traveling route PR for automatic driving.

As described above, in the second embodiment, as is the case with the first embodiment, in a case where the collision probability at which the own vehicle 50 collides with the other object is equal to or more than the predetermined threshold, the damage-expected power source is disconnected from the particular auxiliary units and one or more power sources other than the damage-expected power source are connected to the particular auxiliary units. Thus, even in a case where a collision occurs, power can be continuously supplied to the particular auxiliary units, enabling a reduction in the probability of secondary damage resulting from damage to the damage-expected power source or a power loss in the particular auxiliary units. Additionally, in the second embodiment, in a case where the status recognizing unit 220 recognizes the prescribed steering angle change status including condition 1 that the speed of the own vehicle 50 is equal to or lower than the predetermined value, the first steering angle θ1 along the planned traveling route is changed to the second steering angle θ2. Thus, even in a case where the own vehicle 50 is rear-ended by another vehicle while being temporarily stopped or traveling slowly, the probability that the own vehicle 50 is pushed out along the first steering angle θ1 into the opposite lane can be reduced. As a result, the effect of a rear-end collision can be mitigated.

### C. Third Embodiment

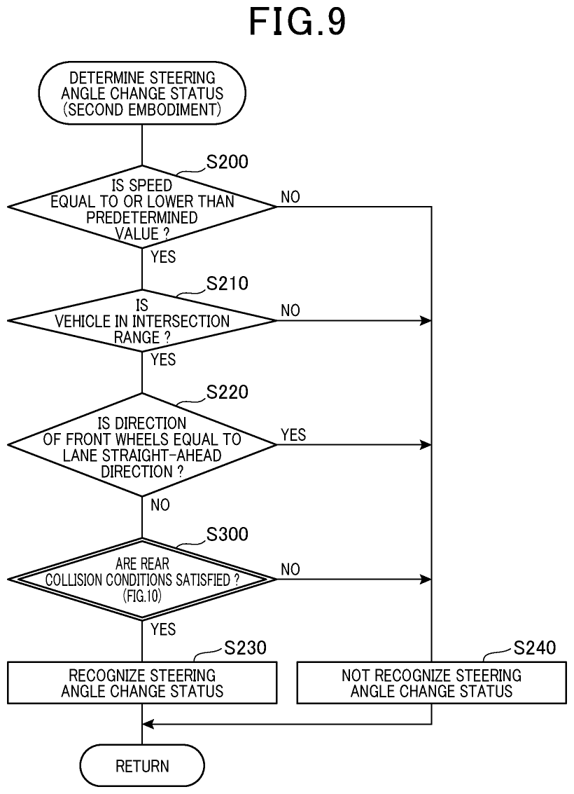

As illustrated in FIG. 9, a third embodiment differs from the second embodiment (FIG. 6) in a detailed procedure for determination of the steering angle change status in step S120 (FIG. 5) but is the same as the second embodiment in the entire procedure for the power source connection change processing illustrated in FIG. 5. That is, in the third embodiment, the procedure in FIG. 5 is used to execute the entire power source connection change processing, and the detailed procedure in FIG. 9 is used to perform the determination in step S120 in FIG. 5.

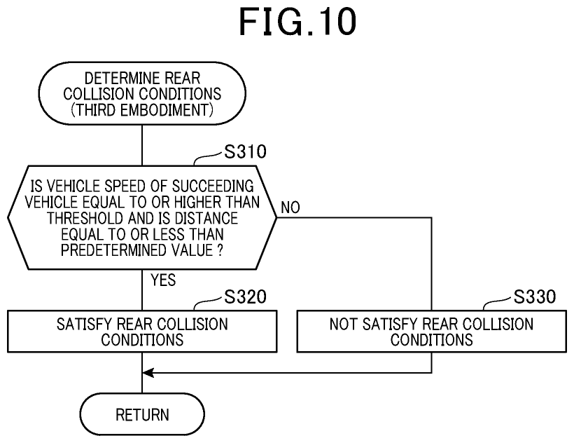

FIG. 9 differs from FIG. 6 in that step S300 is additionally provided between step S220 and step S230. In step S300, whether prescribed rear collision conditions are satisfied is determined. In a case where the rear collision conditions are satisfied, the processing proceeds to step S230, and the status recognizing unit 220 recognizes the steering angle change status. On the other hand, in a case where the rear collision conditions are not satisfied, the processing proceeds to step S240, and the steering angle change status is not recognized. An example of the determination procedure for the rear collision condition is illustrated in FIG. 10.

As illustrated in FIG. 10, step S310 includes determining whether the conditions are satisfied that the vehicle speed of the following vehicle 61 is equal to or higher than a prescribed threshold and that the distance between the own vehicle 50 and the following vehicle 61 is equal to or less than a predetermined value. Whether the succeeding vehicle 61 is present and the rear status including the vehicle speed of the following vehicle 61 and the distance are recognized by the rear recognizing unit 226 in accordance with information provided by the rear detection device 420 (FIG. 1). In a case where affirmative determination is made in step S310, the own vehicle 50 may be rear-ended by the following vehicle 61, and the rear recognizing unit 226 determines in step S320 that the rear collision conditions are satisfied. On the other hand, in a case where negative determination is made in step S310, the rear recognizing unit 226 determines in step S330 that the rear collision conditions are not satisfied.

In a case where the rear collision conditions are satisfied, the processing proceeds to step S230 in FIG. 9, and the status recognizing unit 220 recognizes the steering angle change status. On the other hand, in a case where the rear collision conditions are not satisfied, the processing proceeds to step S240 in FIG. 9, and the steering angle change status is not recognized. The subsequent processing procedure is similar to that in step S130 and the subsequent steps in FIG. 5 according to the second embodiment.

As described above, in the third embodiment, the steering angle change status is employed which includes satisfaction of the rear collision conditions related to the status of the following vehicle in addition to satisfaction of the traveling status conditions related to the traveling conditions for the own vehicle 50. Thus, the first steering angle θ1 is changed to the second steering angle θ2 only in a case where a rear collision may occur. As a result, unnecessary change in steering angle is omitted, and thus, the driver can be restrained from feeling anxiety.

### D. Fourth Embodiment

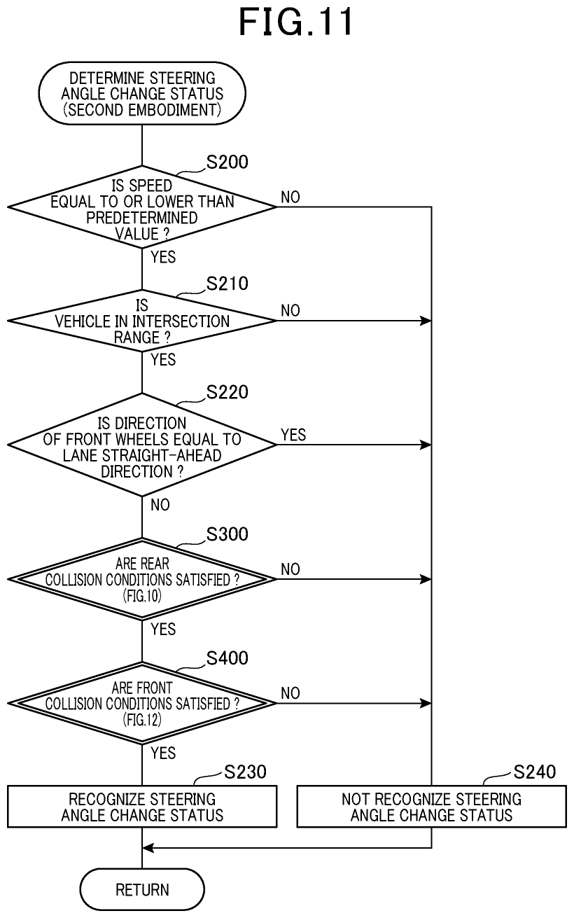

As illustrated in FIG. 11, a fourth embodiment differs from the second embodiment (FIG. 6) and the third embodiment (FIG. 9) in a detailed procedure for determination of the steering angle change status in step S120 (FIG. 5). The fourth embodiment is the same as the second embodiment in the entire procedure for the power source connection change processing illustrated in FIG. 5. Additionally, the fourth embodiment is the same as FIG. 10 of the third embodiment in the detailed procedure for the rear collision conditions in step S300. That is, in the fourth embodiment, the procedure in FIG. 5 is used to execute the entire power source connection change processing, and the detailed procedure in FIG. 11 is used to perform the determination in step S120 in FIG. 5. Additionally, the determination in step S300 in FIG. 11 is executed using the detailed procedure in FIG. 10, which is the same as that in the third embodiment.

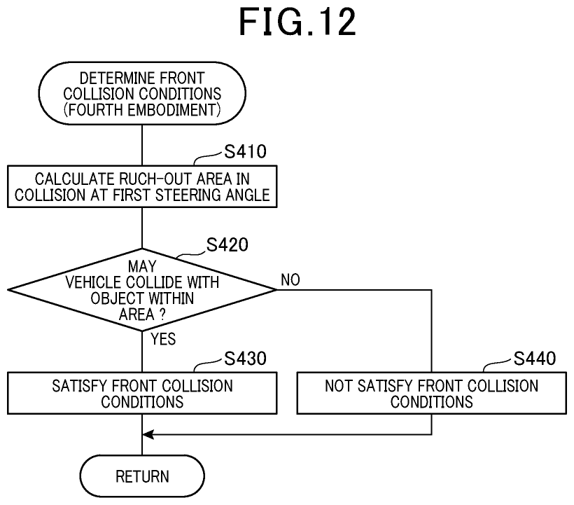

FIG. 11 differs from FIG. 9 in that step S400 is additionally provided between step S300 and S230. In step S400, whether prescribed front collision conditions are satisfied is determined. In a case where the front collision conditions are satisfied, the processing proceeds to step S230, and the status recognizing unit 220 recognizes the steering angle change status. On the other hand, in a case where the front collision conditions are not satisfied, the processing proceeds to step S240, in which the steering angle change status is not recognized. An example of a determination procedure for the front collision conditions is illustrated in FIG. 12.

As illustrated in FIG. 12, in step S410, in a case where the own vehicle 50 is assumed to be rear-ended at the first steering angle θ1, an area where the own vehicle 50 rushing out (shunted) forward in a rear-end collision passes (hereinafter referred to as the “rush-out area FA” or “shunt area FA”) is calculated.

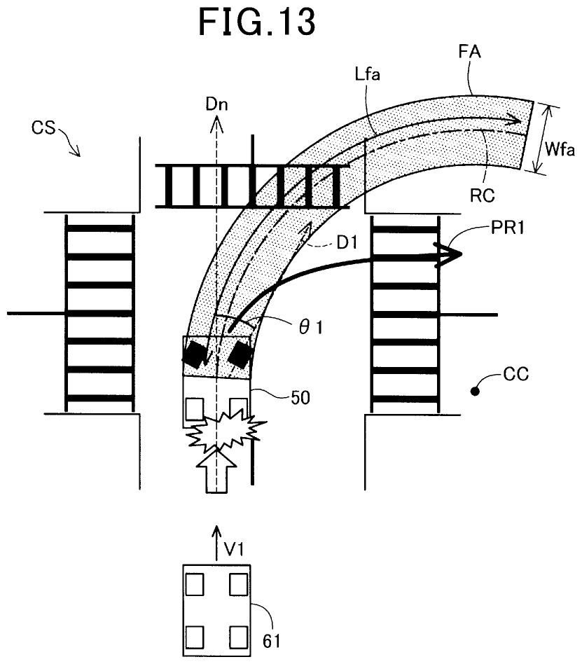

As illustrated in FIG. 13, the rush-out area FA can be calculated as an area described by the vehicle width of the own vehicle 50 along a circle RC around a turning center CC when the own vehicle 50 is rear-ended. A radius R of the clearance circle RC can be calculated, for example, by:

R=L/sin(θ1) (1)

where L is a wheel base of the own vehicle 50.

A width Wfa of the rush-out area FA is the width of the area described by the vehicle width of the own vehicle 50 along the radius R. A length Lfa of the rush-out area FA is the length of a curve followed by the center of the rush-out area FA and is a distance over which the own vehicle 50 travels in a rear-end collision until the own vehicle 50 is stopped.

The radius R of the rush-out area FA may be set to a value obtained by using, as a reference, a value determined by Equation (1) described above and experimentally and empirically correcting the value with the first steering angle θ1 and other parameters (for example, the vehicle speed and weight of the following vehicle 61 and the weight of the own vehicle 50) taken into account. This also applies to the width Wfa of the rush-out area FA and the length Lfa of the rush-out area FA. Note that the length Lfa of the rush-out area FA is preferably set to increase consistently with the vehicle speed of the following vehicle 61. The length Lfa of the rush-out area FA may be up to a position where the area reaches the end of a sidewalk at the intersection CS.

The radius R, width Wfa, and length Lfa of the rush-out area FA may be contained in a map or a lookup table using, as input, one or more parameters such as the vehicle speed and weight of the following vehicle 61, the weight of the own vehicle 50, and the first steering angle θ1 and using, as output, the radius R, width Wfa, and length Lfa of the rush-out area FA, the map or the lookup table being stored in a nonvolatile memory not illustrated. Note that the various parameters used to calculate the rush-out area FA can be acquired using the functions of the assistance information acquiring unit 400. For example, the vehicle speed and weight of the following vehicle 61 can be acquired directly from the following vehicle 61 by inter-vehicle communication.

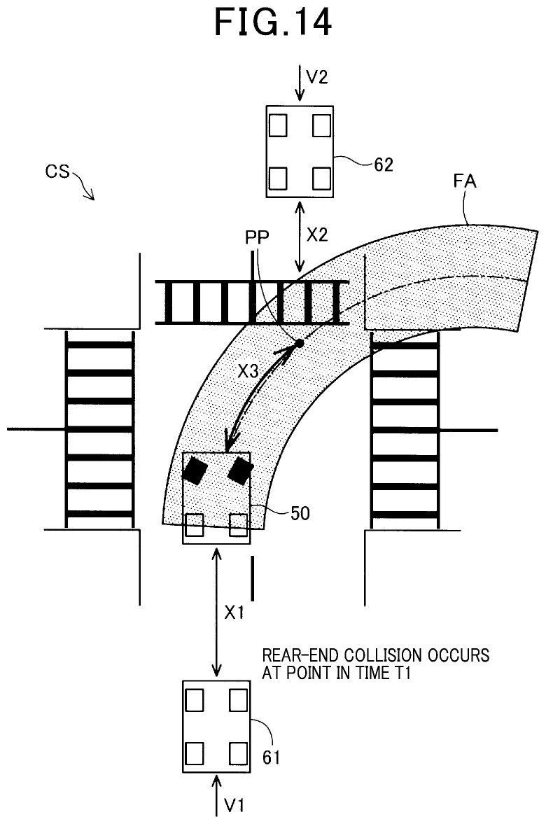

In step S420 in FIG. 12, whether there is a probability that the own vehicle 50 collides with the other object in the rush-out area FA. If there is a probability that the own vehicle 50 collides with the other object, the front collision conditions are determined to be satisfied in step S430. On the other hand, if there is no probability that the own vehicle 50 collides with the other object, the front collision conditions are determined not to be satisfied in step S440. An example of a front collision status is illustrated in FIG. 14.

As illustrated in FIG. 14, it is assumed that, while the own vehicle 50 is temporarily stopped, another vehicle (hereinafter referred to as the “front vehicle 62”) is approaching the intersection CS from front. In FIG. 14,

X1 is a distance from the following vehicle 61 to the own vehicle 50 at the current point in time (T=0),

V1 is vehicle speed of the following vehicle 61,

X2 is a distance from the front vehicle 62 to an outer edge of the rush-out area FA at the current point in time (T=0),

V2 is vehicle speed of the front vehicle 62, and

X3 is an estimated moving distance over which the own vehicle 50 moves after a rear-end collision until the own vehicle 50 collides with the front vehicle 62.

At this time, for example, in a case where Equation (2) below is satisfied, affirmative determination is made in step S420.

−α<T2−(T1+T3)<β (2)

where

α and β are predetermined time margin,

T1 is a time until the own vehicle 50 is rear-ended by the following vehicle 61 (T1=X1/V1),

T2 is a time until the front vehicle 62 reaches the rush-out area FA (T2=X2/V2), and

T3 is an estimated time from the time when the own vehicle 50 is rear-ended until the own vehicle 50 collides with the front vehicle 62 (T3=X3/(k×V2).

Note that a coefficient k used for calculation of the time T3 is less than 1. The coefficient k may be determined in accordance with one or more parameters, for example, the weight of the own vehicle 50 and the vehicle speed and weight of the following vehicle 61, or may be set to a predetermined constant value.

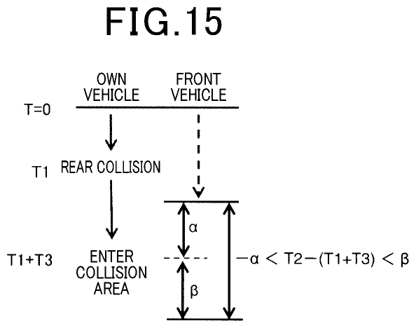

FIG. 15 indicates the meaning of Equation (2) described above. In this case, the own vehicle 50 is estimated to be rear-ended at the point in time T1 that is the time T1 after the current point in time (T=0), and at a point in time (T1+T3) that is the time T3 after the point in time T1, the own vehicle 50 is estimated to reach a point PP (FIG. 14) in the rush-out area FA. The point PP is, for example, an intersection point between a clearance circle RC passing through the center of the rush-out area FA and a straight-ahead course of the front vehicle 62. On the other hand, the front vehicle 62 is estimated to reach the rush-out area FA at the point in time T2 that is the time T2 after the current point in time (T=0). At this time, when a difference between the point in time (T1+T3) when the own vehicle 50 reaches the point PP and the point in time T2 when the front vehicle 62 reaches the rush-out area FA is in a predetermined range, the own vehicle 50 is likely to collide with the front vehicle 62. Equation (2) described above indicates a relationship with high probability of a collision. Note that a is a time margin for the front vehicle 62 to pass through the rush-out area FA earlier than the own vehicle 50 and that β is a time margin for the own vehicle 50 passes through the rush-out area FA before the front vehicle 62 reaches the rush-out area FA. Each of the time margins α and β is a positive value and can be set to a value in the range, for example, from 2 to 3 seconds or in the range from 5 to 10 seconds. In a case where the probability of a front collision is to be estimated on a safe side, each of the time margins α and β are set to a large value (for example, a value in the range from 5 to 10 seconds).

Note that, in the determination in FIG. 14, in a case where the other object (front vehicle 62, human being, or the like) possibly colliding with the own vehicle 50 within the rush-out area FA is stopped, the speed V2 of the other object is zero. In this case, the time T2 is set to zero, and the determination in Equation (2) above can be performed. At this time, only in a case where an other object is present within the rush-out area FA, the front collision conditions may be determined to be satisfied.

The various parameters used in step S420 are acquired by the assistance information acquiring unit 400 as necessary. As the “other object” in step S420, a vehicle, a pedestrian, a road facility (traffic signal or road sign) may be taken into account. Note that, in a case where the object possibly colliding with the own vehicle 50 is a pedestrian or a vehicle, avoiding a possible collision is more necessary and that the pedestrian or the vehicle may thus exclusively be considered as the “other object”.

Referring back to FIG. 12, in a case where affirmative determination is made in step S420, the own vehicle 50 may collide with the front object, and thus the front collision conditions are determined to be satisfied in step S430. On the other hand, in a case where negative determination is made in step S420, the front collision conditions are determined not to be satisfied in step S440.

In a case where the front collision conditions are satisfied, the processing proceeds to step S230 in FIG. 11, and the status recognizing unit 220 recognizes the steering angle change status. On the other hand, in a case where the front collision conditions are determined not to be satisfied, the processing proceeds to step S240 in FIG. 9, and the steering angle change status is not recognized. The subsequent processing procedure is similar to that in step S130 and the subsequent steps in FIG. 5 according to the second embodiment.

Note that, in the procedure in FIG. 11, step S300 may be omitted and that, immediately after step S220, whether the front collision conditions are satisfied may be determined in step S400. In this case, in the calculations and predictions described with reference to FIGS. 13 to 15, preset default values can be used as the parameters related to the following vehicle 61 (speed, weight, and distance). Additionally, in the procedure in FIG. 11, the execution order of step S300 and step S400 may be changed such that step S400 is executed before step S300. However, in a case where step S400 is executed after step S300 as illustrated in FIG. 11, the parameters (vehicle speed and the like) related to the following vehicle 61 can be utilized for the determination in step S400, thus advantageously allowing the rush-out area FA to be more accurately calculated.

As described above, the fourth embodiment employs the steering angle change status including satisfaction of the rear collision conditions related to the following vehicle and satisfaction of the front collision conditions related to the front object, in addition to satisfaction of the traveling status conditions related to the traveling conditions for the own vehicle 50. Thus, the first steering angle θ1 is changed to the second steering angle θ2 only in a case where a front collision may be caused by a rear collision. As a result, the probability of unnecessary change in steering angle is lower than in the second embodiment, and thus, the driver can be restrained from having an anxious feeling.

### E. Fifth Embodiment

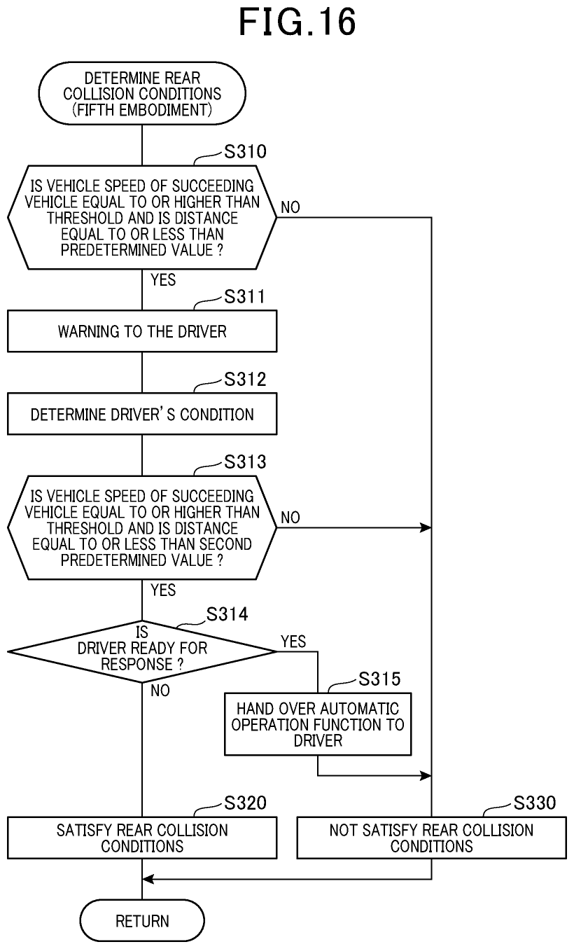

As illustrated in FIG. 16, a fifth embodiment corresponds to the third embodiment in which the detailed procedure for the rear collision conditions illustrated in FIG. 10 is changed. The procedure of the fifth embodiment differs from the procedure of third embodiment (FIG. 10) in the determination procedure for the rear collision conditions but is the same as the procedure of the third embodiment in the processing procedure for steering angle change processing described with reference to FIG. 9. That is, in the fifth embodiment, the procedure in FIG. 5 is used to execute the entire power source connection change processing, the detailed procedure in FIG. 9 is used to perform the determination in step S120 in FIG. 5, and the detailed procedure in FIG. 16 is used to perform the determination in step S300 in FIG. 9. Note that, in the fifth embodiment, as the detailed procedure for step S120 in FIG. 5, the procedure of the fourth embodiment described with reference to FIG. 11 may be used instead of the procedure of the third embodiment described with reference to FIG. 9.

FIG. 16 differs from FIG. 10 in that steps S311 to S315 are additionally provided between step S310 and step S320. Step S310 includes determining whether the conditions are satisfied that the vehicle speed of the following vehicle 61 is equal to or higher than a prescribed threshold and that the distance between the own vehicle 50 and the following vehicle 61 is equal to or less than a first predetermined value. Step S310 is substantially the same as step S310 in FIG. 10; the “predetermined value” in step S310 described with reference to FIG. 10 is changed to the “first predetermined value”. In a case where negative determination is made in step S310, the rear collision conditions are determined not to be satisfied in step S330. At this time, the processing proceeds to step S240 in FIG. 9, and the steering angle change status is not recognized. On the other hand, in a case where affirmative determination is made in step S310, the processing proceeds to step S311.

In step S311, the automatic driving control unit 210 causes the driver warning unit 500 to warn the driver that the following vehicle 61 is approaching the own vehicle 50. The warning can be provided by, for example, generating a warning sound or displaying a warning image. At this time, the warning may also include other information such as information indicating that the vehicle speed of the following vehicle 61 is equal to or higher than a predetermined value, an expected time before a possible collision, and the like.

In step S312, the automatic driving control unit 210 causes the driver state detecting unit 510 to determine the state of the driver. Specifically, for example, an in-vehicle camera (not illustrated) is used to capture an image of the face of the driver, and a captured image screen is analyzed to specify the eyes, nose, and mouth of the driver. Then, a focus direction of the driver is determined based on the eyes, nose, and mouth of the driver. Here, the “focus direction of the driver” means the direction in which the driver is paying attention. Note that, for determination of the focus direction, facial recognition may be utilized to identify the driver and a preset value specific to the driver may be utilized to determine the focus direction. The driver state detecting unit 510 can utilize the focus direction of the driver to determine awareness of the driver (whether the driver is inattentive). Additionally, the driver state detecting unit 510 may utilize an eyeblink frequency (frequency of opening and closing of the eyes) or movement of the head to determine awareness.

Step S313 includes determining whether the conditions are satisfied that the vehicle speed of the following vehicle 61 is equal to or higher than a prescribed threshold and that the distance between the own vehicle 50 and the following vehicle 61 is equal to or less than a second predetermined value. The second predetermined value for the distance used in step S313 is smaller than the first predetermined value used in step S311. Note that, as the threshold for the vehicle speed, the same value as that in step S311 can be used but that a value different from that in step S311 may be used. In a case where negative determination is made in step S313, the rear collision conditions are determined not to be satisfied in step S330. At this time, the processing proceeds to step S240 in FIG. 9, the steering angle change status is not recognized. On the other hand, in a case where affirmative determination is made in step S313, the own vehicle 50 may be rear-ended by the following vehicle 61, and the processing proceeds to step S314.

Note that step S313 may be omitted and that step S314 may be executed immediately after step S312. Additionally, the execution order of step S312 and step S313 may be reversed. However, in a case where step S313 is executed after step S312, a quick response can be provided in preparation for a rear-end collision with the following vehicle 61. On the other hand, in a case where step S313 is executed before step S312, the processing ends without determination of the driver state when negative determination is made in step S313. This enables a reduction in calculation loads in the automatic driving ECU 200.

Step S314 includes determining whether the state of the driver detected by the driver state detecting unit 510 indicates that the driver is ready for a response to a rear-end collision, specifically, whether the driver can perform operation in preparation for a rear-end collision in which the own vehicle 50 is hit by the following vehicle 61. The determination can be comprehensively performed based on the various parameters (focus direction and awareness of the driver) detected in step S312 and indicating the state of the driver. In a case where the driver is determined not to be ready for a response to a rear-end collision, the rear collision conditions are determined to be satisfied in step S320. On the other hand, in a case where the driver is determined to be ready for a response to a rear-end collision, the processing proceeds to step S315.

In step S315, the automatic driving control unit 210 hands over, to the driver, at least some of the control functions for automatic driving including the steering angle control function. Three main control functions for automatic driving include the driving unit control function, the brake control function, and the steering angle control function. That is, the “control functions for automatic driving” are functions to transmit indication values to the control devices 310, 320, and 330 (FIG. 1) to cause the control devices to perform control operations. In a case where a rear-end collision may occur, the steering angle control for changing the direction of the front wheels is considered to be important for reducing damage in a rear-end collision by operation of the driver. Thus, in step S315, at least the steering angle control function, included in the control functions for automatic driving, is preferably handed over to the driver. Note that, in step S315, in addition to the steering angle control function, one or both of the driving unit control function and the brake control function may be handed over to the driver. After the control functions are handed over to the driver, the processing proceeds to step S330, and the rear collision conditions are determined not to be satisfied.

In a case where the rear collision conditions are satisfied, the processing proceeds to step S230 in FIG. 9, and the status recognizing unit 220 recognizes the steering angle change status. On the other hand, in a case where the rear collision conditions are not satisfied, the processing proceeds to step S240 in FIG. 9, and the steering angle change status is not recognized. The subsequent processing procedure is similar to that in step S130 and the subsequent steps in FIG. 5 according to the second embodiment.

As described above, in the fifth embodiment, in a case where the state of the driver detected by the driver state detecting unit 510 indicates that the driver is ready to perform operations in preparation for a collision in which the own vehicle 50 is hit by the following vehicle 61, the automatic driving control unit 210 determines the rear collision conditions not to be satisfied. Additionally, at least some of the control functions for automatic driving including the steering angle control function are handed over to the driver. Thus, in a case where the driver is ready for a response to a rear-end collision, damage in a rear-end collision can be reduced by operation by the driver.

### F. Sixth Embodiment

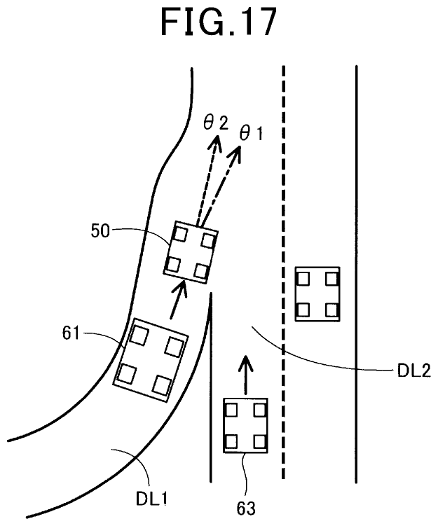

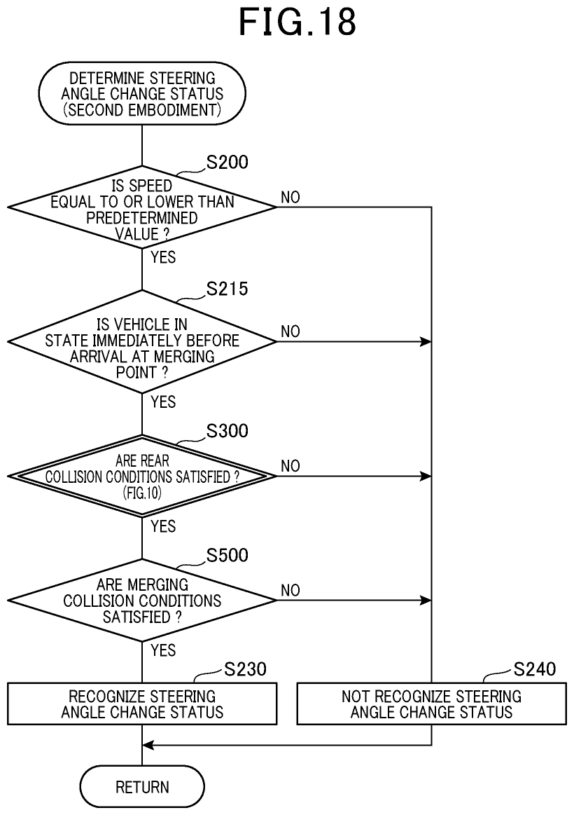

As illustrated in FIG. 17, in a sixth embodiment, it is assumed that the own vehicle 50 having traveled in a first lane DL1 enters a second line DL2 merging with the first lane DL1. In this case, at the current position, the own vehicle 50 is in a state immediately before arrival at a position where the first lane DL1 merges with the second line DL2, and the own vehicle 50 is temporarily stopped or traveling slowly. The following vehicle 61 may be approaching the own vehicle 50 from behind. Additionally, another vehicle 63 is traveling in the second line DL2 toward the merging point. For example, information related to the another vehicle 63 can be acquired utilizing the intelligent transport system 70 or inter-vehicle communication, and the status recognizing unit 220 can utilize this information to acquire the traveling status of the another vehicle 63 described above. Under such circumstances, in a case where the own vehicle 50 is rear-ended by the following vehicle 61, the own vehicle 50 may collide with the another vehicle 63 traveling in the second line DL2. A determination procedure for the steering angle change status illustrated in FIG. 18 is executed to reduce the effect of collisions in such circumstances.

As illustrated in FIG. 18, the sixth embodiment differs from the second embodiment (FIG. 6) in the detailed procedure for determination of the steering angle change status in step S120 (FIG. 5) but is the same as the second embodiment in the entire procedure for the power source connection change processing illustrated in FIG. 5. That is, in the sixth embodiment, the procedure in FIG. 5 is used to execute the entire power source connection change processing, and the detailed procedure in FIG. 18 is used to perform the determination in step S120 in FIG. 5.

FIG. 18 differs from FIG. 6 in that steps S210 and S220R in FIG. 6 are omitted and that steps S215, S300, and S500 are additionally provided between step S200 and step S230. Step S215 includes determining whether the own vehicle 50 is positioned to be to reach the position where the first lane DL1 merges with the second line DL2. This determination is performed depending on whether the current position of the own vehicle 50 is in a predetermined range from the merging point of the lanes. In a case where negative determination is made in step S215, the processing proceeds in step S240, and the steering angle change status is not recognized. On the other hand, in a case where affirmative determination is made in step S215, in step S300, whether the rear collision conditions are satisfied is determined. Step S300 is executed by the procedure in FIG. 10 described in the third embodiment or the procedure in FIG. 16 described in the fifth embodiment. In a case where the rear collision conditions are not satisfied, the processing proceeds to step S240, and the steering angle change status is not recognized. On the other hand, in a case where the rear collision conditions are satisfied, in step S500, whether prescribed merging collision conditions are satisfied is determined.

The determination of the merging collision conditions in step S500 is performed, for example, by calculating, as a rush-out area, an area where the own vehicle 50 rushing out (is shunted) forward in a rear-end collision passes in a case where the own vehicle 50 is rear-ended at the first steering angle θ1, and determining whether the own vehicle 50 may collide, within the rush-out area, with the another vehicle 63 traveling in the second line DL2. The determination can be performed in accordance with the manner described using FIGS. 13 to 15 in the fourth embodiment, and detailed description of the determination is omitted.

In a case where the merging collision conditions are satisfied, the processing proceeds to step S230, and the status recognizing unit 220 recognizes the steering angle change status. On the other hand, in a case where the merging collision conditions are not satisfied, the processing proceeds to step S240, and the steering angle change status is not recognized. Note that, in the procedure in FIG. 18, step S300 may be omitted and that immediately after step S215, whether the merging collision conditions are satisfied may be determined in step S500.

Note that, in the sixth embodiment, as illustrated in FIG. 17, the second steering angle θ2 employed in a case where the steering angle change status is recognized is preferably set to cause the own vehicle 50 to travel in a direction farther away from the second line DL2 than the first steering angle θ1. This enables a further reduction in the probability of a collision at the merging point.

As described above, in the sixth embodiment, in a case where, at the current position, the own vehicle 50 is in a state immediately before arrival at the point where the first lane DL1 merges with the second line DL2, the steering angle of the own vehicle 50 is changed from the first steering angle θ1 along the planned traveling route to the second steering angle θ2 in a case where the merging collision conditions are satisfied that indicate that the own vehicle 50 may be rear-ended and collide with the another vehicle 63. Thus, even in a case where the own vehicle 50 is rear-ended while being temporarily stopped or traveling slowly at a position where the own vehicle 50 is in a state immediately before arrival at the merging point for the first lane DL1 and the second line DL2, the probability that the own vehicle 50 is pushed out along the first steering angle θ1 into the second line DL2 can be reduced. As a result, the effect of a rear-end collision can be mitigated.

### G. Seventh Embodiment

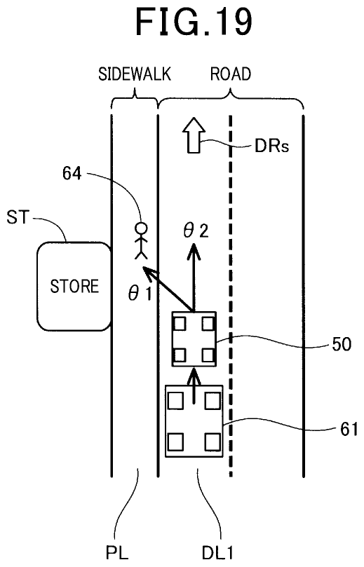

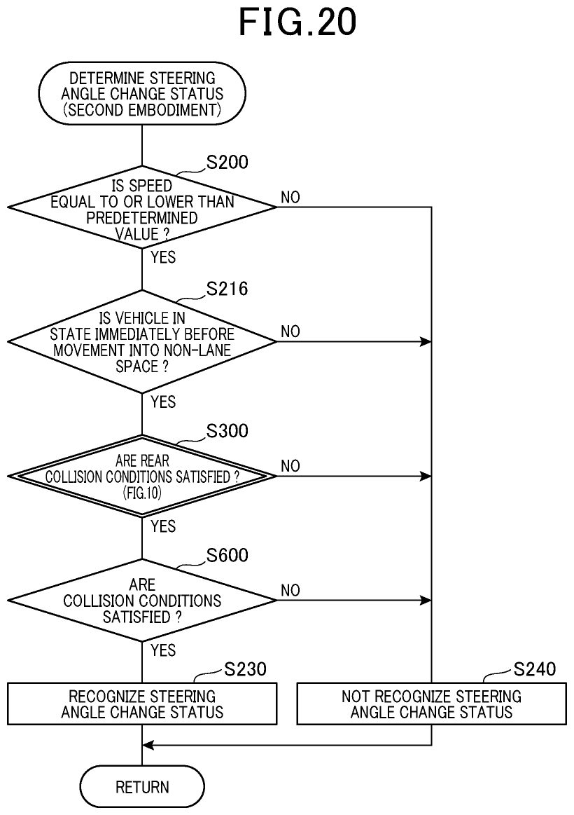

As illustrated in FIG. 19, in a seventh embodiment, it is assumed that the own vehicle 50 traveling in the first lane DL1 moves into a space (hereinafter referred to as a “non-lane space”) that is not a road (lane) for traveling of vehicles. In this case, the non-lane space is a sidewalk PL in front of a store ST. Note that, as the non-lane space, besides the sidewalk, various spaces such as a parking lot can be assumed. At the current position, the own vehicle 50 is in a state immediately before movement from the first lane DL1 onto the sidewalk PL as a non-lane space, and the own vehicle 50 is temporarily stopped or traveling slowly. The following vehicle 61 may be approaching the own vehicle 50 from behind. Additionally, an other object 64 such as a human being or a bicycle may be present on the sidewalk PL. The object 64 can travel into a path along which the own vehicle 50 moves from the first lane DL1 onto the sidewalk PL as a non-lane space. The status of the other object 64 described above can be detected, for example, using the front detection device 410 and recognized by the front recognizing unit 224 utilizing the result of the detection. Under such circumstances, in a case where the own vehicle 50 is rear-ended by the following vehicle 61, the own vehicle 50 may collide with the other object 64 on the sidewalk PL. A determination procedure for the steering angle change status illustrated in FIG. 20 is executed to reduce the effect of a collision under such circumstances.

The determination procedure for the steering angle change status according to the seventh embodiment illustrated in FIG. 20 corresponds to the sixth embodiment illustrated in FIG. 18 and in which step S215 and step S500 are respectively replaced with step S216 and step S600. The seventh embodiment is the same as the second embodiment in the entire procedure for the power source connection change processing illustrated in FIG. 5. That is, in the seventh embodiment, the procedure in FIG. 5 is used to execute the entire power source connection change processing, and the detailed procedure in FIG. 20 is used to perform the determination in step S120 in FIG. 5.

Step S216 includes determining whether, at the current position, the own vehicle 50 is in a state immediately before movement into the non-lane space. In a case where negative determination is made in step S216, the processing proceeds to step S240, and the steering angle change status is not recognized. On the other hand, in a case where affirmative determination is made in step S216, whether the rear collision conditions are satisfied is determined in step S300. Step S300 is executed using the procedure in FIG. 10 described in the third embodiment or the procedure in FIG. 16 described in the fifth embodiment. In a case where the rear collision conditions are not satisfied, the processing proceeds to step S240, and the steering angle change status is not recognized. On the other hand, in a case where the rear collision conditions are satisfied, whether prescribed collision conditions are satisfied is determined in step S600.

The determination of the collision conditions in step S600 is performed, for example, by calculating, as a rush-out area, an area where the own vehicle 50 rushing out forward in a rear-end collision passes in a case where the own vehicle 50 is rear-ended at the first steering angle θ1, and determining whether the own vehicle 50 may collide with the other object 64 within the rush-out area. The determination can be performed in accordance with the manner described using FIGS. 13 to 15 in the fourth embodiment, and detailed description of the determination is omitted.

In a case where the collision conditions are satisfied, the processing proceeds to step S230, and the status recognizing unit 220 recognizes the steering angle change status. In a case where the collision conditions are not satisfied, the processing proceeds to step S240, and the steering angle change status is not recognized. Note that, in the procedure in FIG. 20, step S300 may be omitted and that immediately after step S216, whether the collision conditions are satisfied may be determined in step S600.

Note that, in the seventh embodiment, as illustrated in FIG. 19, the second steering angle θ2 employed in a case where the steering angle change status is recognized is preferably set such that the direction of the front wheels indicated by the second steering angle θ2 is closer to the lane straight-ahead direction DRs in the first lane DL1 than the direction indicated by the first steering angle θ1. This enables a further reduction in the probability of a collision with the other object 64.

As described above, in the seventh embodiment, in a case where the collision conditions are satisfied that indicate that, at the current position, the own vehicle 50 is in a state immediately before movement from the lane for traveling for vehicles into the non-lane space and that the own vehicle 50 may be rear-ended and collide with the other object 64, the steering angle of the own vehicle 50 is changed from the first steering angle θ1 along the planned traveling route to the second steering angle θ2. Thus, even in a case where the own vehicle 50 is rear-ended while being temporarily stopped or traveling slowly at a position where the own vehicle 50 is in a state immediately before movement into the non-lane space, the probability that the own vehicle 50 rushes out along the first steering angle θ1 to collide with the other object 64 can be reduced. As a result, the effect of a rear-end collision can be mitigated.

### H. Eighth Embodiment

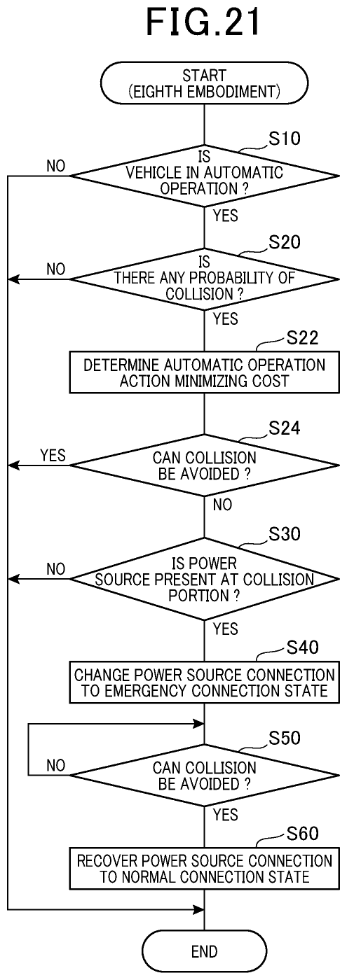

As illustrated in FIG. 21, a procedure for power source connection change processing according to an eighth embodiment is the same, in processing, as the procedure in the first embodiment except that steps S22 and S24 are additionally provided between step S20 and step S30 in FIG. 3. In step S20, in a case where the probability of a collision is determined, in step S22, the status recognizing unit 220 calculates the cost of a plurality of automatic driving actions that may be employed by the automatic driving control unit 210 and determines the automatic driving action minimizing the cost. As the plurality of automatic driving actions, various combinations of the driving unit indication value, the brake indication value, and the steering angle indication value may be employed. The cost of each automatic driving action can be calculated by performing simulation utilizing a plurality of parameters, for example, the relative speed between the own vehicle 50 and the other object, the structures and weights of the own vehicle 50 and the other object, the collision direction, the type of the other object (whether the other object includes a human being), and a collision portion. Alternatively, a map or a lookup table using these parameters as input and the cost as output may be utilized to determine the cost. The “cost” is an indicator of a value increasing consistently with the evaluated severity of the result of a collision and is comprehensively determined with not only an economic cost but also a mental cost taken into account. For example, in a case where the other object includes a human being, the mental cost and the cost of the corresponding automatic driving action tend to be high. Note that the various parameters used to calculate the cost can be acquired by the assistance information acquiring unit 400. In a case where the automatic driving action with the minimum cost is determined, the automatic driving action is employed to control the own vehicle 50. Additionally, a portion of the own vehicle 50 expected to be hit by the other object in that automatic driving action is also determined.

In step S24, whether the automatic driving action employed in step S22 allows a possible collision to be avoided is determined. In a case where the possible collision can be avoided, the processing in FIG. 21 ends. On the other hand, in a case where the possible collision fails to be avoided, the processing proceeds to step S30, and the power source circuit 620 is switched to the emergency connection state. The processing in step S30 and the subsequent steps are similar to those in the first embodiment illustrated in FIG. 3.

As described above, in the eighth embodiment, in a case where the vehicle may collide with the other object, the status recognizing unit 220 calculates the cost related to the plurality of automatic driving actions that may be employed by the automatic driving control unit 210, and employs the automatic driving action minimizing the cost. Accordingly, in a case where a possible collision is unavoidable, the automatic driving can be performed so as to minimize the cost of the collision. Additionally, in a case where the automatic driving action employed fails to avoid the collision, the status recognizing unit 220 recognizes the damage-expected power source expected to be hit by the other object, and the automatic driving control unit 210 instructs the power source control ECU 610 to disconnect the damage-expected power source from the particular auxiliary units and to connect one or more power sources other than the damage-expected power source to the particular auxiliary units. Thus, even in a case where a collision occurs, power can be continuously supplied to the particular auxiliary units, enabling a reduction in the probability of secondary damage resulting from damage to the damage-expected power source or a power loss in the particular auxiliary units.

### I. Modified Example

The present disclosure is not limited to the above-described embodiments and modified examples of the embodiments. The present disclosure can be implemented in various aspects without departing from the spirits of the disclosure, and for example, the following modifications can be made.

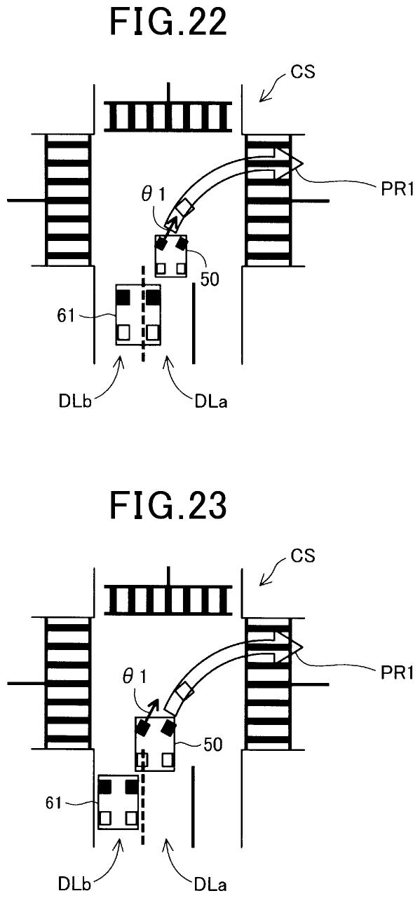

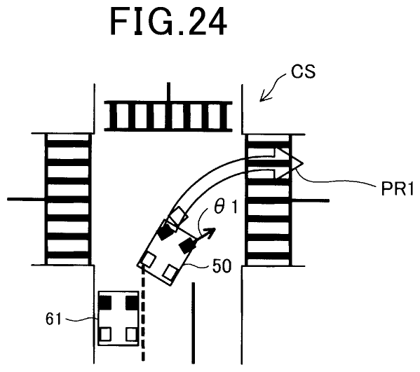

(1) In the second to fifth embodiments, the following vehicle 61 is a vehicle traveling in the same line as that in which the own vehicle 50 travels but may be a vehicle traveling in a next lane. FIGS. 22 to 24 illustrate examples where the following vehicle 61 traveling in a lane DLb next to a lane DLa in which the own vehicle 50 is traveling collides with the own vehicle 50. FIG. 22 illustrates an example where the following vehicle 61 traveling straight ahead in the next lane DLb strays onto the lane DLb and collides with the own vehicle 50. FIG. 23 illustrates an example where, in a case where the own vehicle 50 is temporarily stopped protruding out from the lane DLa, the following vehicle 61 traveling straight ahead in the next lane DLb collides with the own vehicle 50. FIG. 24 illustrates an example where, in a case where the own vehicle 50 is stopped with the left rear portion of the own vehicle 50 protruding into the next lane DLb as a result of a slight turn, the following vehicle 61 traveling straight ahead in the next lane DLb collides with the own vehicle 50. In these cases, by switching the steering angle of the own vehicle 50 from the first steering angle θ1 along the planned traveling route PR1 to the second steering angle θ2, which is different from the first steering angle θ1, the own vehicle 50 can be restrained from being pushed out into the opposite lane.

Note that, as illustrated in the examples in FIG. 22 and FIG. 23, the own vehicle 50 in the intersection CS may not be banked. The own vehicle 50 may be in a state where a steering wheel has not been turned. In this case, the first steering angle θ1 is a steering angle along the straight-ahead direction in the lane DLa, which corresponds to a neutral state. Even in that case, shunting into the opposite lane caused by a partial collision with the following vehicle 61 traveling in the next lane DLb can be suppressed by setting, in preparation for the push-out, the second steering angle θ2 such that the direction of the wheels is opposite, across the neutral direction, to the direction indicated by the first steering angle θ1.

(2) In each of the above-described embodiments, the vehicle in which the front wheels are steered has been described. However, the present disclosure is applicable to a vehicle in which rear wheels are steered.

(3) Some of the steps described in each of the above-described embodiments can be appropriately omitted or the execution order of the steps can be appropriately changed. Additionally, the embodiments can be optionally combined together. For example, the same automatic driving control system may be used to implement any two or more processes included in one of the processes for the intersection described in the second to fifth embodiments, the process for the merging point described in the sixth embodiment, the process T for entry into the non-lane space described in the seventh embodiment.

According to an aspect of the present disclosure, an automatic driving control system is provided which is configured to perform automatic driving to cause an own vehicle to travel along a planned traveling route. The automatic driving control system includes a plurality of power sources installed in the own vehicle and each capable of supplying power to a particular auxiliary unit of the own vehicle, a relay device changing connection states of the plurality of power sources for the particular auxiliary units, a relay control device controlling the relay device, a status recognizing unit capable of recognizing a status of the own vehicle on the planned traveling route and a status of an object around the own vehicle, and an automatic driving control unit indicating the connection states of the plurality of power sources to the relay control device and controlling automatic driving. The status recognizing unit recognizes that a collision probability at which the own vehicle collides with the object during the automatic driving is equal to or more than a predetermined threshold, and in a case where the collision probability is equal to or more than the predetermined threshold, also recognizes a damage-expected power source included in the plurality of power sources and expected to be damaged in a collision with the object. In a case where the collision probability is equal to or more than the predetermined threshold, the automatic driving control unit instructs the relay control device to disconnect the damage-expected power source from the particular auxiliary units and to connect, to the particular auxiliary units, one of the plurality of power sources that is not a damage-expected power source.

According to the automatic driving control unit in this form, in the case where the collision probability at which the own vehicle collides with the object is equal to or more than the predetermined threshold, the relay control device is instructed to disconnect, from the particular auxiliary units, the damage-expected power source expected to be damaged in a collision with the object and to connect, to the particular auxiliary units, one of the plurality of power sources that is not the damage-expected power source. Thus, even in a case where a collision occurs, power can be continuously supplied to the particular auxiliary units, enabling a reduction in the probability of secondary damage resulting from damage to the damage-expected power source or a power loss in the particular auxiliary units.

What is claimed is:

1. An automatic driving control system configured to perform automatic driving to cause an own vehicle to travel along a planned traveling route, the automatic driving control system comprising:
a plurality of power sources installed in the own vehicle and each capable of supplying power to particular auxiliary units of the own vehicle;
a relay device changing connection states of the plurality of power sources for the particular auxiliary units;
a relay control device controlling the relay device;
a status recognizing unit capable of recognizing a status of the own vehicle on the planned traveling route and a status of an object around the own vehicle; and
an automatic driving control unit indicating the connection states of the plurality of power sources to the relay control device and controlling automatic driving, wherein
the status recognizing unit recognizes that a collision probability at which the own vehicle collides with the object during the automatic driving is equal to or more than a predetermined threshold, and in a case where the collision probability is equal to or more than the predetermined threshold, also recognizes a damage-expected power source included in the plurality of power sources and expected to be damaged in a collision with the object,
in a case where the collision probability is equal to or more than the predetermined threshold, the automatic driving control unit instructs the relay control device to disconnect the damage-expected power source from the particular auxiliary units and to connect, to the particular auxiliary units, one of the plurality of power sources that is not the damage-expected power source, and
in a case where the status recognizing unit recognizes that the collision probability is equal to or more than the predetermined threshold, the status recognizing unit calculates a cost related to a plurality of automatic driving actions employable by the automatic driving control unit, employs an automatic driving action minimizing the cost, and determines a portion of the own vehicle expected to be hit by the object in the employed automatic driving action.

2. The automatic driving control system according to claim 1, wherein
in a case where the status recognizing unit recognizes that the collision probability is equal to or more than the predetermined threshold, the automatic driving control unit instructs the relay control device to change a normal connection state where two or more of the plurality of power sources are connected in parallel with the particular auxiliary units to an emergency connection state where the damage-expected power source is disconnected from the particular auxiliary units and where the one of the plurality of power sources that is not the damage-expected power source is connected to the particular auxiliary units.

3. The automatic driving control system according to claim 1, wherein
the particular auxiliary units include at least one of the automatic driving control unit, the status recognizing unit, a brake control device, and a steering angle control device.

4. The automatic driving control system according to claim 1, further comprising:
a steering angle control unit controlling a steering angle of wheels of the own vehicle, wherein
after instructing the relay control device to disconnect the damage-expected power source from the particular auxiliary units and to connect, to the particular auxiliary units, one of the plurality of power sources that is not the damage-expected power source, the automatic driving control unit changes the steering angle indicated to the steering angle control unit from a first steering angle along the planned traveling route to a second steering angle different from the first steering angle in a case where the status recognizing unit recognizes a prescribed steering angle change status including satisfaction of a condition that a speed of the own vehicle is equal to or lower than a predetermined value.

5. The automatic driving control system according to claim 4, wherein
the steering angle change status includes satisfaction of a condition that a current position of the own vehicle is present in a predetermined range from a center of an intersection.

6. The automatic driving control system according to claim 5, wherein
the first steering angle is an angle making a direction of the wheels of the own vehicle different from a lane straight-ahead direction at the intersection, and
the second steering angle is an angle changing and making the direction of the wheels closer to the lane straight-ahead direction than the first steering angle.

7. The automatic driving control system according to claim 6, wherein
the second steering angle is an angle setting the direction of the wheels equal to a neutral direction parallel to a front-rear direction of the own vehicle or an angle setting the direction of the wheels equal to a direction, across the neutral direction, opposite to a direction indicated by the first steering angle.

8. The automatic driving control system according to claim 4, wherein
the status recognizing unit is capable of recognizing an approaching status of a following vehicle traveling behind the own vehicle, and
the steering angle change status further includes satisfaction of rear collision conditions in which the approaching status of the following vehicle is preset.

9. The automatic driving control system according to claim 8, wherein
the status recognizing unit is further capable of recognizing a front object present in front of the own vehicle, and
the steering angle change status further includes satisfaction of front collision conditions indicating that there is a probability that the own vehicle is rear-ended by the following vehicle and collides with the front object.

10. The automatic driving control system according to claim 8, further comprising:
a driver state detecting unit detecting a state of a driver of the own vehicle, wherein
in a case where the state of the driver detected by the driver state detecting unit indicates that the driver is ready to perform operation in preparation for a collision in which the own vehicle is hit by the following vehicle, the status recognizing unit determines the rear collision conditions not to be satisfied, and the automatic driving control unit hands over, to the driver, at least some of control functions for the automatic driving control system including a steering angle control function.

11. The automatic driving control system according to claim 4, wherein
in a case where a second lane is present that merges with a first lane in which the own vehicle is positioned and where, at the current position, the own vehicle is in a state immediately before arrival at a position where the first lane merges with the second line,
the status recognizing unit is further capable of recognizing a traveling status of an other vehicle traveling in the second lane, and
the steering angle change status further includes satisfaction of merging collision conditions indicating that there is a probability that the own vehicle will be rear-ended and collides with the other vehicle.

12. The automatic driving control system according to claim 4, wherein
in a case where, at the current position, the own vehicle is in a state immediately before movement from a lane for traveling of vehicles into a non-lane space,
the status recognizing unit is further capable of recognizing an object capable of traveling into a path along which the own vehicle moves from the lane into the non-lane space, and
the steering angle change status further includes satisfaction of collision conditions indicating that there is a probability that the own vehicle is rear-ended and collides with the object.

13. The automatic driving control system according to claim 4, wherein
in a case where the automatic driving control unit causes the steering angle control unit to change the first steering angle to the second steering angle while the own vehicle is stopped, the automatic driving control unit causes the steering angle control unit to hold the second steering angle until a driving force is applied to the wheels of the vehicle when the own vehicle starts traveling.
